(19) United States
(12) Patent Application Publication
(10) Pub. No.: US 2024/0379051 A1
(43) Pub. Date: Nov. 14, 2024

(54) DISPLAY DEVICE

(71) Applicant: SHARP KABUSHIKI KAISHA, Sakai City, Osaka (JP)

(72) Inventors: HIROYUKI FURUKAWA, Sakai City, Osaka (JP); MASAFUMI UENO, Sakai City, Osaka (JP); Chie TORIDONO, Sakai City, Osaka (JP); Masafumi KAWAI, Sakai City, Osaka (JP)

(21) Appl. No.: 18/686,268

(22) PCT Filed: Oct. 15, 2021
(86) PCT No.: PCT/JP2021/038201

§ 371 Date: Feb. 23, 2024

(51) Int. Cl. G09G 3/32

(52) U.S. Cl. CPC G09G 3/32; G09G 2320/045; G09G 2340/0464

(57) ABSTRACT

A display device includes a display panel that includes a deterioration characteristic acquisition unit that acquires deterioration characteristic data indicating a degree of deterioration of each of a plurality of pixels, a deterioration characteristic storage unit that compresses the deterioration characteristic data, stores the compressed deterioration characteristic data, and decompresses the stored deterioration characteristic data, a display region shifting unit that generates, from an input image data, shifted image data in which a display region is shifted along a display surface of the display panel, a deterioration compensation unit that generates control data obtained by transforming the shifted image data using the decompressed deterioration characteristic data, to compensate for the deterioration of each of the plurality of pixels, and a drive unit that drives the display panel using the control data, to display the input image in the shifted display region.

### TECHNICAL FIELD

The disclosure relates to a display device.

### BACKGROUND ART

A display device including a self-light-emitting element, such as an organic light emitting diode (OLED), a quantum dot light emitting diode (QLED), or a micro light emitting diode (LED), has been developed. When such a display device is used for a long period of time, the self-light-emitting element deteriorates. Thus, luminance of the self-light-emitting element is reduced. As a result, even when a predetermined current is supplied to the self-light-emitting element, a display panel cannot obtain desired brightness. In order to compensate for the reduction in the brightness of the display panel, deterioration characteristic data of each pixel of the display panel is created. The deterioration characteristic data is data indicating a value of the reduced luminance of each of the pixels of the display panel. For example, according to the technique described in PTL 1, in order to suppress an increase in a storage capacity of the deterioration characteristic data, the deterioration characteristic data is stored as data compressed by an error diffusion method, and the compressed data is decompressed before the data is used.

### CITATION LIST

### Patent Literature

PTL 1: JP 2018-025639 A

### SUMMARY OF INVENTION

### Technical Problem

According to the technique disclosed in PTL 1 described above, when the deterioration characteristic data, that is, a high frequency component of the spatial frequency of an image sticking amount of each of the pixels is included, variations in the deterioration characteristic data become large. Thus, unless the number of bits of data storing the deterioration characteristic data is increased, a restoration error becomes large when decompressing the compressed deterioration characteristic data. Thus, it is desired to reduce the restoration error of the deterioration characteristic data while suppressing an increase in the storage capacity of the deterioration characteristic data.

The disclosure has been made in view of the problem described above. An object of the disclosure is to provide a display device capable of reducing a restoration error of deterioration characteristic data while suppressing an increase in a storage capacity of the deterioration characteristic data.

### Solution to Problem

A display device according to an embodiment of the disclosure includes a display panel including a plurality of pixels and configured to display an input image corresponding to input image data, in a display region formed by a part of the plurality of pixels, a deterioration characteristic acquisition unit configured to acquire deterioration characteristic data indicating a degree of deterioration of each of the plurality of pixels, a deterioration characteristic storage unit configured to compress the deterioration characteristic data, store the deterioration characteristic data being compressed, and decompress the deterioration characteristic data being stored, a display region shifting unit configured to generate, from the input image data, shifted image data in which the display region is shifted along a display surface of the display panel, a deterioration compensation unit configured to generate control data obtained by transforming the shifted image data using the deterioration characteristic data being decompressed, to compensate for the deterioration of each of the plurality of pixels, and a drive unit configured to drive the display panel using the control data, to display the input image in the display region being shifted.

### BRIEF DESCRIPTION OF DRAWINGS

FIG. 1 is a diagram for describing an overall configuration of a display device according to a first embodiment.

FIG. 2A is a diagram illustrating a display region of the display device according to the first embodiment.

FIG. 2B is a diagram illustrating a region in which image sticking occurs when the display region of a display panel of the display device according to the first embodiment is shifted.

FIG. 3A is a diagram illustrating a shift amount of an I-V characteristic in an X-axis direction of the display panel, when the display region of the display device according to the first embodiment is not shifted.

FIG. 3B is a diagram illustrating the shift amount of the I-V characteristic in the X-axis direction of the display panel, when the display region of the display device according to the first embodiment is shifted.

FIG. 4A is a diagram illustrating a difference between the shift amounts of the I-V characteristics of adjacent pixels in the X-axis direction of the display panel, when the display region of the display device according to the first embodiment is not shifted.

FIG. 4B is a diagram illustrating the difference between the shift amounts of the I-V characteristics of the adjacent pixels in the X-axis direction of the display panel, when the display region of the display device according to the first embodiment is shifted.

FIG. 5 is a first diagram for describing a method for compressing and decompressing deterioration characteristic data in a deterioration characteristic storage unit of the display device according to a second embodiment.

FIG. 6 is a second diagram for describing the method for compressing and decompressing the deterioration characteristic data in the deterioration characteristic storage unit of the display device according to the second embodiment.

FIG. 7 is a third diagram for describing the method for compressing and decompressing the deterioration characteristic data in the deterioration characteristic storage unit of the display device according to the second embodiment.

FIG. 8 is a fourth diagram for describing the method for compressing and decompressing the deterioration characteristic data in the deterioration characteristic storage unit of the display device according to the second embodiment.

FIG. 9 is a fifth diagram for describing the method for compressing and decompressing the deterioration characteristic data in the deterioration characteristic storage unit of the display device according to the second embodiment.

FIG. 10 is a diagram for describing a configuration of the deterioration characteristic storage unit of the display device according to a third embodiment.

FIG. 11 is a diagram for describing a method for compressing and decompressing the deterioration characteristic data in the deterioration characteristic storage unit of the display device according to the third embodiment.

FIG. 12 is a diagram for describing an overall configuration of the display device according to a fourth embodiment.

FIG. 13A is a diagram illustrating the shift amount of the I-V characteristic in the X-axis direction of the display panel, when a deterioration of the display region of the display device according to the fourth embodiment is small.

FIG. 13B is a diagram illustrating the difference between the shift amounts of the I-V characteristics of the adjacent pixels in the X-axis direction of the display panel, when the deterioration of the display region of the display device according to the fourth embodiment is small.

FIG. 14A is a diagram illustrating the shift amount of the I-V characteristic in the X-axis direction of the display panel, when the deterioration of the display region of the display device according to the fourth embodiment is large.

FIG. 14B is a diagram illustrating the difference between the shift amounts of the I-V characteristics of the adjacent pixels in the X-axis direction of the display panel, when the deterioration of the display region of the display device according to the fourth embodiment is large.

FIG. 15A is a diagram illustrating the shift amount of the I-V characteristic in the X-axis direction of the display panel, when a shift distance of the display region is increased as an average degree of deterioration of the display device according to the fourth embodiment increases.

FIG. 15B is a diagram illustrating the difference between the shift amounts of the I-V characteristics of the adjacent pixels in the X-axis direction of the display panel, when the shift distance of the display region is increased as the average degree of deterioration of the display device according to the fourth embodiment increases.

FIG. 16A is a partial enlarged view in which a part of FIG. 14A and a part of FIG. 15A are overlaid with each other in order to compare FIG. 14A with FIG. 15A.

FIG. 16B is a partial enlarged view in which a part of FIG. 14B and a part of FIG. 15B are overlaid with each other in order to compare FIG. 14B with FIG. 15B.

### DESCRIPTION OF EMBODIMENTS

Hereinafter, a display device according to embodiments of the present invention will be described with reference to the accompanying drawings. Further, in the drawings, the same or equivalent elements are denoted by the same reference numerals and signs, and repeated descriptions thereof will be omitted.

### First Embodiment

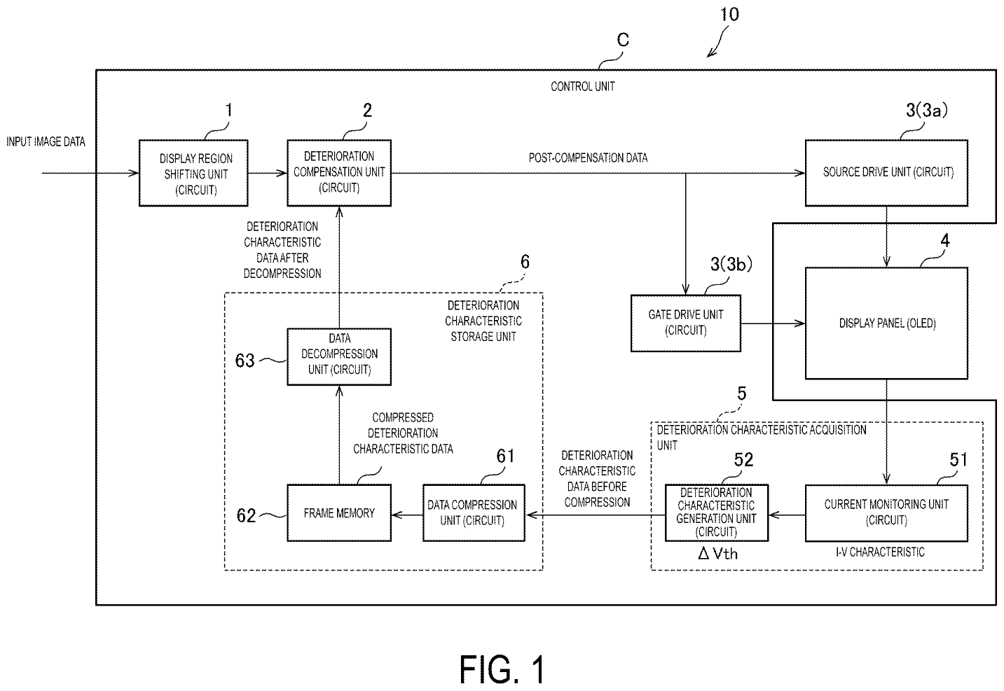

FIG. 1 is a diagram for describing an overall configuration of a display device 10 according to a first embodiment.

As illustrated in FIG. 1, the display device 10 includes a display panel 4 and a control unit C that controls the display panel 4. The control unit C includes a display region shifting unit 1, a deterioration compensation unit 2, a drive unit 3, a deterioration characteristic acquisition unit 5, and a deterioration characteristic storage unit 6.

The display panel 4 includes a plurality of pixels. Each of the plurality of pixels includes a plurality of self-light-emitting elements. Examples of the self-light-emitting element include an organic light emitting diode (OLED), a quantum dot light emitting diode (QLED), and a micro light emitting diode (LED). Further, each of the plurality of pixels includes a thin film transistor (TFT) that controls the current caused to flow through the self-light-emitting element.

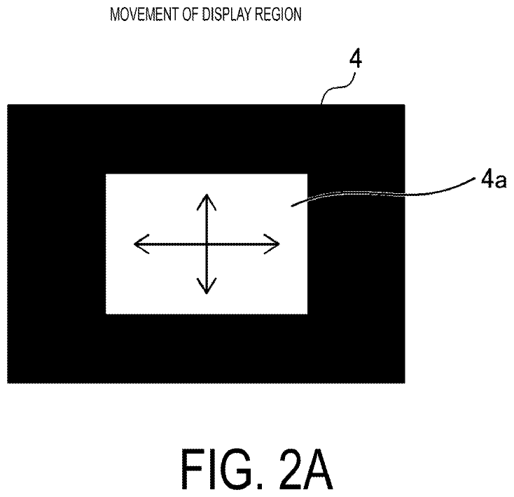

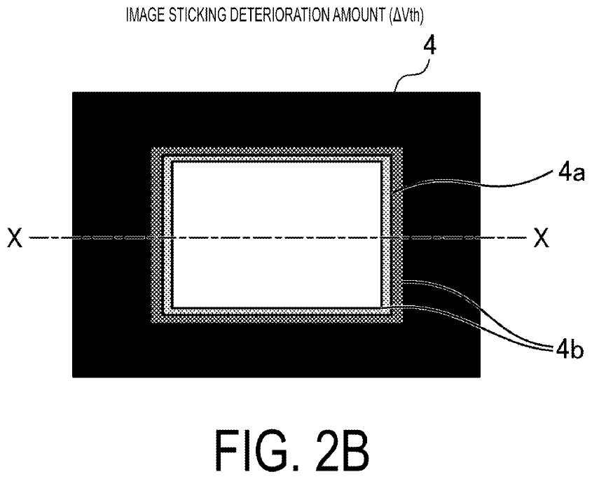

For example, a degree of deterioration of the self-light-emitting element of the pixel constituting the display panel 4 is mainly correlated with a value obtained by multiplying the magnitude of the current caused to flow through the self-light-emitting element by a period of time in which the current is caused to flow through the self-light-emitting element. In other words, when the self-light-emitting element emits light at high luminance for a long period of time, the self-light-emitting element rapidly deteriorates. When the self-light-emitting element deteriorates, a voltage Vth required to cause a predetermined current to flow through the self-light-emitting element increases. In addition, when the self-light-emitting element deteriorates, a mobility u decreases. Furthermore, when a fixed pattern is continuously displayed at a high luminance on the display panel 4 for a long period of time, the deterioration of the self-light-emitting elements corresponding to a portion of the fixed pattern significantly progresses, thereby causing a reduction in the luminance of the self-light-emitting elements corresponding to the portion of the fixed pattern. A level difference in luminance caused by a level difference in a deterioration amount of each of the voltage Vth and the mobility u is observed between the self-light-emitting elements corresponding to the portion of the fixed pattern and the self-light-emitting elements corresponding to a portion other than the portion of the fixed pattern. Such a phenomenon is called image sticking. Thus, a display region 4a (see FIG. 2A and FIG. 2B) of the display panel 4 is periodically shifted. As a result, the inclination of the level difference in the deterioration amount of each of the voltage Vth and the mobility u between a region where the deterioration of the self-light-emitting element is large and a region where the deterioration of the self-light-emitting element is small can be made gentler. Note that, in a similar manner as with the self-light-emitting element, the TFT of the pixel constituting the display panel also deteriorates when a current is caused to flow therethrough. Thus, with respect to each of the threshold voltage and the mobility of the TFT, a level difference also arises in the deterioration amount, which is caused by displaying the fixed pattern for a long period of time. Then, by periodically shifting the display region 4a of the display panel 4, the inclination of the level difference in the deterioration amount of each of the threshold voltage and the mobility of the TFT between a region where the deterioration of the TFT is large and a region where the deterioration of the TFT is small can be made gentler.

The display region shifting unit 1 receives input image data from the outside of the display device 10, and shifts the display region 4a of an input image corresponding to the received input image data by a shifting amount in the display panel 4. Specifically, the display region shifting unit 1 shifts the input image data in at least one of the horizontal direction and the vertical direction of the display panel 4.

The deterioration compensation unit 2 receives, from the display region shifting unit 1, the input image data in which the display region 4a has been shifted. Further, the deterioration compensation unit 2 receives decompressed deterioration characteristic data from the deterioration characteristic storage unit 6, and, using the decompressed deterioration characteristic data, compensates for a reduction in the luminance of each of the pixels, which is specified by the input image data in which the display region 4a has been shifted by the shifting amount. As a result, the deterioration compensation unit 2 transmits, to the drive unit 3, post-compensation data, that is, the input image data in which the display region 4a has been shifted by the shift amount and the deterioration of each of the pixels has been compensated for. More specifically, the deterioration compensation unit 2 transmits compensation data received from the deterioration compensation unit 2, to each of a source drive unit 3a and a gate drive unit 3b.

The drive unit 3 includes the source drive unit 3a and the gate drive unit 3b. The source drive unit 3a transmits each corresponding gray scale data (gray scale value), of the input image data, to a source electrode of each of the pixels constituting the display panel 4. The gate drive unit 3b transmits an ON signal to a gate electrode of each of the pixels constituting the display panel 4. Each of the source drive unit 3a and the gate drive unit 3b receives the compensation data from the deterioration compensation unit 2, and displays, in the shifted display region 4a of the display panel 4, the input image corresponding to the input image data in a state where the deterioration of each of the pixels in the display region 4a has been compensated for.

The deterioration characteristic acquisition unit 5 includes a current monitoring unit 51 and a deterioration characteristic generation unit 52. The current monitoring unit 51 applies a monitor voltage to the display panel 4. Thereafter, the current monitoring unit 51 reads a current value I from the display panel 4 to the outside. As a result, the current monitoring unit 51 acquires data indicating an I-V characteristic of at least one of the self-light-emitting element and the TFT constituting the pixel. Note that, although the deterioration of the self-light-emitting element will be described below, the deterioration of the TFT can also be described in the same manner.

The deterioration characteristic generation unit 52 generates the deterioration characteristic data based on the data indicating the I-V characteristic, which has been received from the current monitoring unit 51. The deterioration characteristic data is at least one of a shift amount ΔVth, which is an amount of change over time of the voltage Vth from an initial value (or a prescribed value) thereof, and Δμ, which is an amount of change over time of the mobility u from an initial value (or a prescribed value) thereof, of the self-light-emitting element included in each of the group of pixels constituting the display panel 4. A method for generating the deterioration characteristic data may be any method such as calculation by a computing unit or selection of a value in a data table. Hereinafter, the shift amount ΔVth will be described, but the same description can also be applied to Δμ.

The deterioration characteristic storage unit 6 includes a data compression unit 61, a frame memory 62, and a data decompression unit 63. The data compression unit 61 receives the deterioration characteristic data generated by the deterioration characteristic generation unit 52, compresses the received deterioration characteristic data, and transmits the compressed deterioration characteristic data to the frame memory 62. In the present embodiment, the data compression unit 61 performs so-called differential encoding in which data is compressed by calculating a differential value between the deterioration characteristic data of adjacent pixels. The frame memory 62 stores the deterioration characteristic data in a compressed state. The data decompression unit 63 reads the deterioration characteristic data in the compressed state from the frame memory 62, and decompresses the data. In other words, the data decompression unit 63 restores the deterioration characteristic data. The data decompression unit 63 transmits the deterioration characteristic data to the deterioration compensation unit 2.

In the present embodiment, each of the display region shifting unit 1, the deterioration compensation unit 2, the drive unit 3, the deterioration characteristic acquisition unit 5, and the deterioration characteristic storage unit 6 is configured by a dedicated electronic circuit. However, at least one of the display region shifting unit 1, the deterioration compensation unit 2, the drive unit 3, the deterioration characteristic acquisition unit 5, and the deterioration characteristic storage unit 6 may be realized by software such as a display control program to be described later.

FIG. 2A is a diagram illustrating the display region 4a (a region surrounded by a rectangle indicated by the tip of a leader line extending from reference sign 4a) of the display device 10 according to the first embodiment. As can be seen from FIG. 2A, in the present embodiment, the display region 4a has a rectangular shape. The display region 4a is arranged near the center of the display panel 4 in which the group of pixels are arranged in a rectangular shape. The display region 4a may be shifted vertically and horizontally. The display region shifting unit 1 of the control unit C receives the input image data from the outside of the display device 10, and shifts the display region 4a of the input image corresponding to the received input image data upward or downward and leftward or rightward by the shifting amount in the display panel 4. The display region shifting unit 1 may shift the display region 4a only in the upward or downward direction, or only in the leftward or rightward direction.

FIG. 2B is a diagram illustrating a region where the image sticking occurs when the display region 4a of the display panel 4 of the display device 10 according to the first embodiment is shifted. FIG. 2B illustrates a frame-shaped image sticking region 4b (a region between two rectangles indicated by the tips of two leader lines extending from reference sign 4b) generated by the shift of the display region 4a. In general, the frame-shaped image sticking region 4b has a smaller image sticking amount than a central image sticking region surrounded by the frame-shaped image sticking region 4b. Further, the image sticking amount of the frame-shaped image sticking region 4b changes in a stepwise manner.

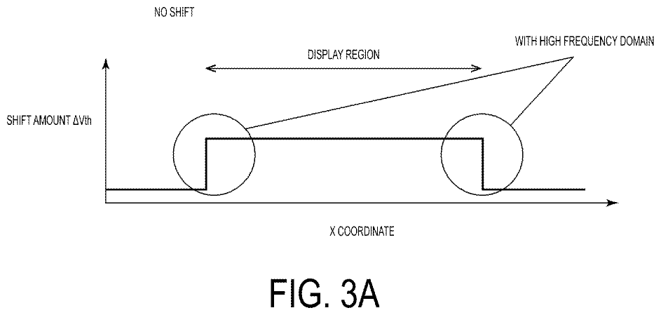

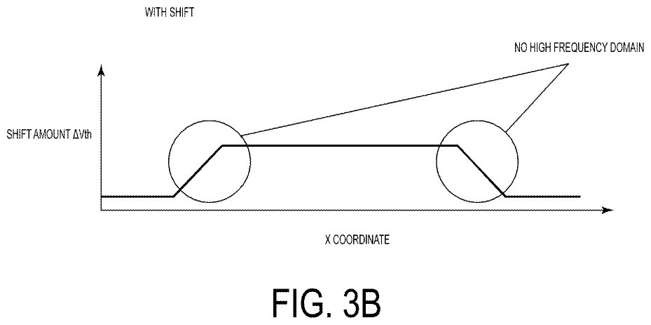

FIG. 3A is a diagram illustrating the shift amount ΔVth of the I-V characteristic in an X-axis direction (see FIG. 2B) of the display panel 4, when the display region 4a of the display device 10 according to the first embodiment is not shifted. FIG. 3B is a diagram illustrating the shift amount ΔVth of the I-V characteristic in the X-axis direction (see FIG. 2B) of the display panel 4, when the display region 4a of the display device 10 according to the first embodiment is shifted. As can be seen by comparing FIG. 3A with FIG. 3B, when the display region 4a is shifted, there is no high frequency domain of the shift amount ΔVth of the I-V characteristic, unlike when the display region 4a is not shifted.

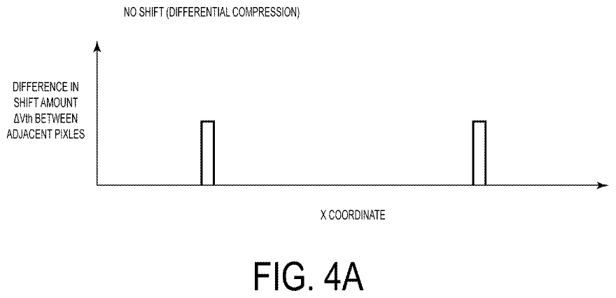

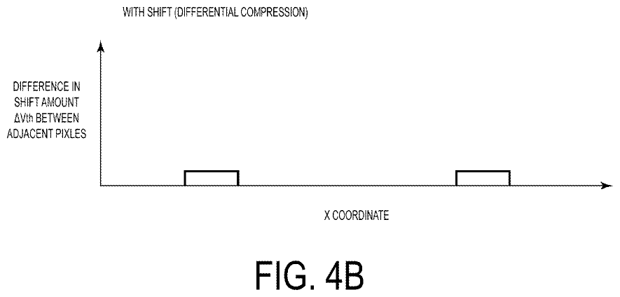

FIG. 4A is a diagram illustrating the difference between the shift amounts ΔVth of the I-V characteristics of the adjacent pixels in the X-axis direction (see FIG. 2B) of the display panel, when the display region 4a of the display device 10 according to the first embodiment is not shifted. FIG. 4B is a diagram illustrating the difference between the shift amounts ΔVth of the I-V characteristics of the adjacent pixels in the X-axis direction (see FIG. 2B) of the display panel 4, when the display region 4a of the display device 10 according to the first embodiment is shifted.

As can be seen from FIG. 4A and FIG. 4B, when the display region 4a is shifted, the difference between the shift amounts ΔVth of the I-V characteristics of the adjacent pixels is smaller than when the display region 4a is not shifted. Thus, if the difference between the shift amounts ΔVth of the I-V characteristics of the adjacent pixels is stored as the deterioration characteristic data, the number of bits of the deterioration characteristic data can be reduced.

As a result, it is possible to suppress an increase in the storage capacity of the frame memory 62 that stores the deterioration characteristic data. In addition, according to the above-described method for compressing and decompressing the deterioration characteristic data, the deterioration characteristic data acquired by the deterioration characteristic acquisition unit 5 without shifting the display region is not stored in the frame memory 62 by simply thinning out or changing the deterioration characteristic data. Therefore, no restoration error occurs when the compressed deterioration characteristic data is decompressed.

For this reason, in the present embodiment, the deterioration characteristic storage unit 6 uses the so-called differential encoding, in which a difference between two degrees of deterioration (shift amounts ΔVth of the I-V characteristics) corresponding to two pixels adjacent to each other among the plurality of pixels is stored, as the method for compressing and decompressing the deterioration characteristic data.

As can be seen from the above description, the display device 10 according to the present embodiment has the following characteristic configuration.

The display panel 4 displays the input image corresponding to the input image data in the display region 4a formed by some of the plurality of pixels. The deterioration characteristic acquisition unit 5 acquires the deterioration characteristic data indicating the degree of deterioration of each of the plurality of pixels. The deterioration characteristic storage unit 6 compresses the deterioration characteristic data, stores the compressed deterioration characteristic data, and decompresses the stored deterioration characteristic data. The display region shifting unit 1 generates, from the input image data, shifted image data obtained by shifting the display region 4a along a display surface of the display panel 4. The deterioration compensation unit 2 generates control data obtained by transforming the shifted image data using the decompressed deterioration characteristic data, so that the deterioration of each of the plurality of pixels is compensated. The drive unit 3 drives the display panel 4 using the control data so as to display the input image in the shifted display region 4a.

According to the display device 10 of the present embodiment described above, it is possible to reduce the restoration error of the deterioration characteristic data while suppressing an increase in the storage capacity of the deterioration characteristic data.

### Second Embodiment

Next, the display device 10 according to a second embodiment will be described. Note that description of points similar to those in the first embodiment will not be repeated below. The present embodiment differs from the first embodiment in the following respects.

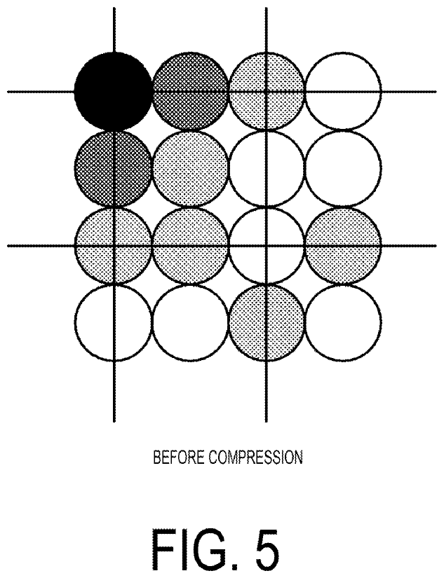

FIG. 5 to FIG. 9 are respectively a first diagram to a fifth diagram for describing a method for compressing and decompressing the deterioration characteristic data of the deterioration characteristic storage unit 6 of the display device 10 according to the second embodiment.

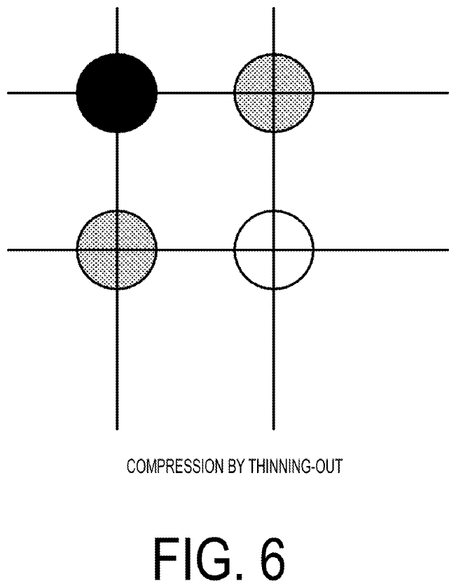

As illustrated in FIG. 5 and FIG. 6, the deterioration characteristic storage unit 6 of the present embodiment compresses the deterioration characteristic data by thinning out the deterioration characteristic data. In the present embodiment, spatial thinning-out is used to compress the deterioration characteristic data. In the spatial thinning-out according to the present embodiment, for example, the deterioration characteristic data of one pixel is sampled every two pixels in each of the horizontal direction and the vertical direction. As a result, a data amount of the deterioration characteristic data after compression can be reduced to ¼ of the data amount of the deterioration characteristic data before compression.

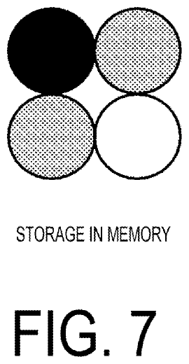

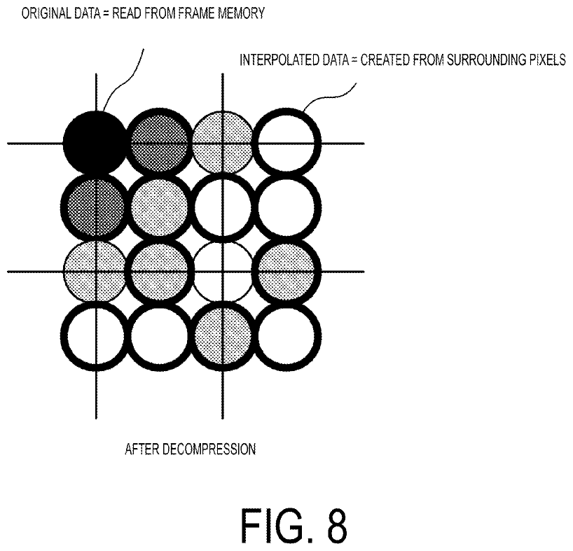

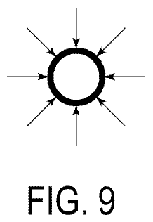

Next, as illustrated in FIG. 7, the deterioration characteristic storage unit 6 stores the compressed deterioration characteristic data by storing the thinned-out deterioration characteristic data. In this case, since the deterioration characteristic data is thinned out, the storage capacity of the frame memory 62 is reduced. Thereafter, as illustrated in FIG. 8, the deterioration characteristic storage unit 6 decompresses the stored deterioration characteristic data by interpolating the thinned-out deterioration characteristic data. As illustrated in FIG. 9, the deterioration characteristic data of a pixel to be interpolated is created using data of eight pixels around the pixel to be interpolated. As an interpolation method, any method such as the bilinear method, the bicubic method, or the Lanczos method may be used. The interpolated deterioration characteristic data is created by weighting using a function in accordance with distances from non-thinned-out pixels surrounding the thinned-out pixels.

Since the deterioration characteristic data after decompression, which has been created by these interpolation methods, has a small spatial high frequency component in principle, the deterioration characteristic data is blurred, that is, the restoration error becomes large. However, in the deterioration characteristic data of the present embodiment, the high frequency domain of the spatial frequency domain is small due to the pixel shift. Therefore, although the compression and decompression by the thinning-out do not have complete reversibility, the deterioration characteristic data before compression can be substantially restored.

Note that it is preferable to perform the pixel shift in a diagonal direction by combining the pixel shifts in the horizontal direction and the vertical direction, rather than performing the pixel shift independently in each of the horizontal direction and the vertical direction. This is to obtain a spatially uniform low pass filter (LPF) effect by the pixel shift when spatially thinning out the deterioration characteristic data.

### Third Embodiment

Next, the display device 10 according to a third embodiment will be described. Note that description of points similar to those in the first embodiment will not be repeated below. The present embodiment differs from the first embodiment in the following respects.

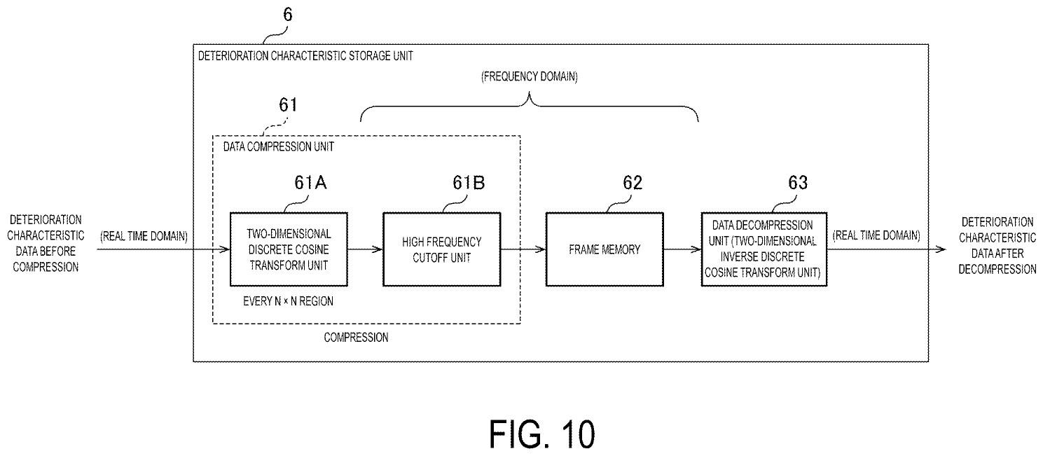

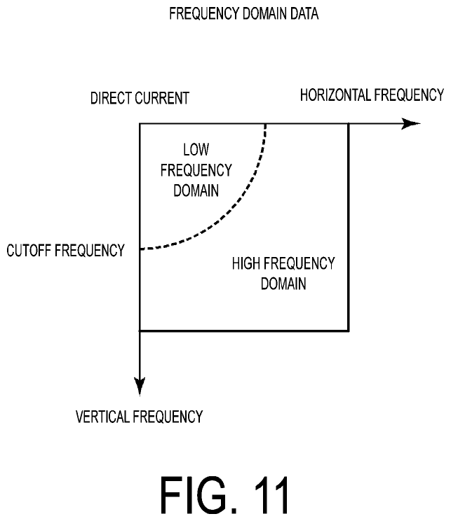

FIG. 10 is a diagram for describing a configuration of the deterioration characteristic storage unit 6 of the display device 10 according to the third embodiment. FIG. 11 is a diagram for describing a method for compressing and decompressing the deterioration characteristic data in the deterioration characteristic storage unit 6 of the display device 10 according to the third embodiment.

As illustrated in FIG. 10, in the present embodiment, the data compression unit 61 of the deterioration characteristic storage unit 6 includes a two-dimensional discrete cosine transform unit 61A and a high frequency cutoff unit 61B. Further, the frame memory 62 is the same as that of the first embodiment. The data decompression unit 63 of the deterioration characteristic storage unit 6 is a two-dimensional inverse discrete cosine transform unit.

In the present embodiment, a two-dimensional discrete cosine transform (DCT) is used to compress the deterioration characteristic data.

According to the deterioration characteristic storage unit 6 of the present embodiment, the two-dimensional discrete cosine transform unit 61A transforms the deterioration characteristic data acquired by the deterioration characteristic acquisition unit 5 into frequency domain data. Specifically, the deterioration characteristic data before compression is subjected to a discrete cosine transform for each region formed by a pixel matrix of N rows×N columns. The transformed deterioration characteristic data becomes two-dimensional frequency domain data.

The high frequency cutoff unit 61B compresses the deterioration characteristic data by removing, from the frequency domain data, the high frequency component of the frequency domain data transformed by the two-dimensional discrete cosine transform unit 61A. Specifically, as illustrated in FIG. 11, a predetermined cutoff frequency is set for the above-described two-dimensional frequency domain data after transform. As a result, from the two-dimensional frequency domain data, of a low frequency domain and a high frequency domain partitioned by the cutoff frequency, the high frequency domain is removed.

Next, the frame memory 62 of the deterioration characteristic storage unit 6 stores the compressed deterioration characteristic data by storing the frequency domain data from which the high frequency component has been removed by the high frequency cutoff unit 61B. In this way, the frame memory 62 does not need to store the high frequency component, and thus stores only a low frequency component.

The above-described cutoff frequency is set in accordance with the frequency or the shifting amount of the pixel shift. In general, more frequently performed pixel shift or a larger shifting amount of the pixel shift allows a lower cutoff frequency to be set, and thus the compression effect is increased.

Thereafter, the two-dimensional inverse discrete cosine transform unit, as the data decompression unit 63, decompresses the stored deterioration characteristic data by inversely transforming the frequency domain data stored in the frame memory 62 into the deterioration characteristic data. Specifically, the deterioration characteristic data in the form of frequency domain data read out from the frame memory 62 is restored to real time domain data formed by a pixel matrix of N rows×N columns by the two-dimensional inverse discrete cosine transform.

According to the method for compressing the deterioration characteristic data of the present embodiment as described above, the high frequency component of the deterioration characteristic data is removed in advance by the pixel shift. Thus, even if the compression rate is increased, it is possible to reduce the restoration error (generally referred to as mosquito noise) generated when the frequency domain data from which the high frequency domain has been removed is restored to the real time domain data.

As described above, in the present embodiment, the two-dimensional discrete cosine transform (DCT) is used to compress the deterioration characteristic data. However, even if a transform other than the two-dimensional discrete cosine transform (DCT) is used for compression, the restoration error can be reduced by using any data transform as long as the method thereof includes transforming the deterioration characteristic data into the frequency domain data and removing the high frequency component of the frequency domain data.

### Fourth Embodiment

Next, the display device 10 according to a fourth embodiment will be described. Note that description of points similar to those in the first embodiment will not be repeated below. The present embodiment differs from the first embodiment in the following respects.

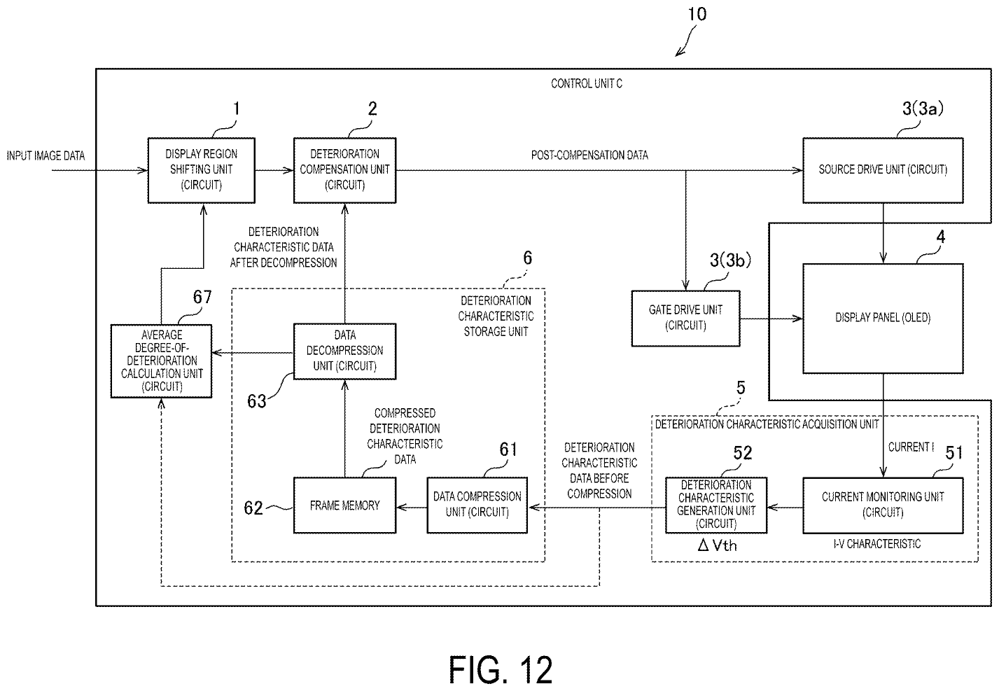

FIG. 12 is a diagram for describing an overall configuration of the display device 10 according to the present embodiment.

As illustrated in FIG. 12, the display device 10 includes, in addition to the configuration of the first embodiment illustrated in FIG. 1, an average degree-of-deterioration calculation unit 67 that calculates an average degree of deterioration of the plurality of pixels constituting the display panel 4 using the deterioration characteristic data decompressed by the data decompression unit 63 of the deterioration characteristic storage unit 6. In this case, the deterioration characteristic data after decompression is used to calculate the average degree of deterioration. The average degree of deterioration is, for example, an average value of the shift amounts ΔVth of all the pixels constituting the display panel 4. In the present embodiment, the average degree-of-deterioration calculation unit 67 is constituted by a dedicated electronic circuit.

However, the display device 10 may include, in addition to the configuration of the first embodiment illustrated in FIG. 1, the average degree-of-deterioration calculation unit 67 that calculates the average degree of deterioration of the plurality of pixels constituting the display panel 4 using the deterioration characteristic data calculated by the deterioration characteristic generation unit 52 of the deterioration characteristic acquisition unit 5. In this case, the deterioration characteristic data before compression is used to calculate the average degree of deterioration.

In the present embodiment, the display region shifting unit 1 receives data indicating the average degree of deterioration from the average degree-of-deterioration calculation unit 67, and increases a shift distance of the display region 4a as the average degree of deterioration increases.

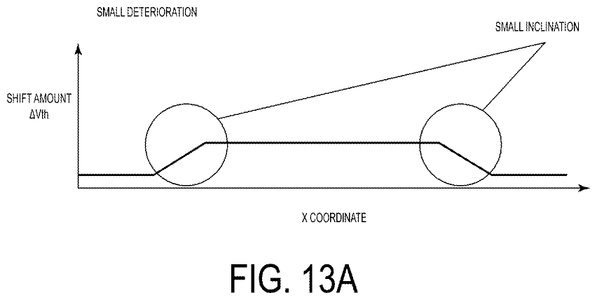

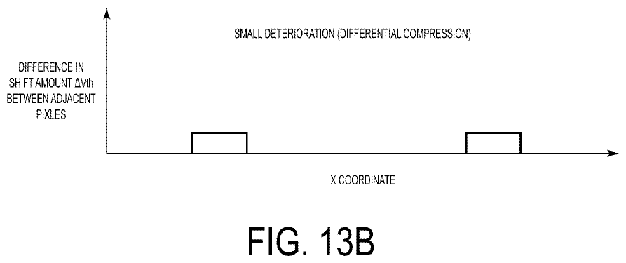

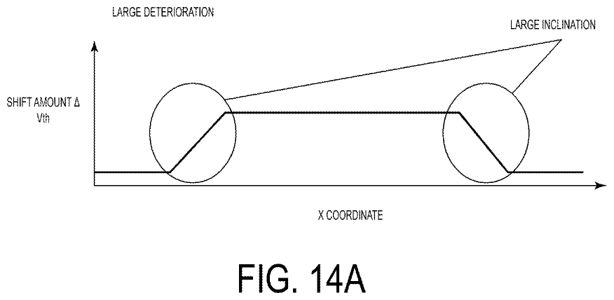

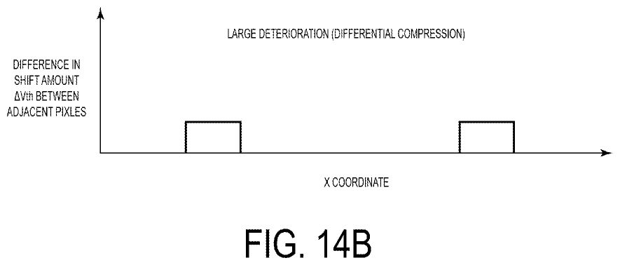

FIG. 13A is a diagram illustrating the shift amount of the I-V characteristic in the X-axis direction (see FIG. 2B) of the display panel 4, when the deterioration of the display region 4a of the display device 10 according to the present embodiment is small. FIG. 13B is a diagram illustrating a difference between the shift amounts ΔVth of the I-V characteristics of the adjacent pixels in the X-axis direction (see FIG. 2B) of the display panel, when the deterioration of the display region 4a of the display device 10 according to the present embodiment is small. FIG. 14A is a diagram illustrating the shift amount ΔVth of the I-V characteristic in the X-axis direction (see FIG. 2B) of the display panel 4, when the deterioration of the display region 4a of the display device 10 according to the present embodiment is large. FIG. 14B is a diagram illustrating the difference between the shift amounts ΔVth of the I-V characteristics of the adjacent pixels in the X-axis direction (see FIG. 2B) of the display panel 4, when the deterioration of the display region 4a of the display device 10 according to the present embodiment is large.

As can be seen by comparing FIG. 13A and FIG. 13B with FIG. 14A and FIG. 14B, if the inclination of the shift amount ΔVth of the I-V characteristic with respect to the X-axis direction (see FIG. 2B) is small, the difference between the shift amounts ΔVth of the I-V characteristics of the adjacent pixels is small. Therefore, it is possible to obtain the effect of reducing the restoration error of the deterioration characteristic data while suppressing an increase in the storage capacity of the deterioration characteristic data. On the other hand, if the inclination of the shift amount ΔVth of the I-V characteristic with respect to the X-axis direction (see FIG. 2B) is large, the difference between the shift amounts ΔVth of the I-V characteristics of the adjacent pixels is large, and thus the above-described effect is reduced.

Thus, as described above, the shifting amount of the display region of the input image data by the display region shifting unit 1 is increased as the degree of deterioration of the pixel, specifically, the shift amount ΔVth of the I-V characteristic increases. In this way, even when the deterioration of the display panel 4 progresses, it is possible to suppress a decrease in the compression rate of data compression of the difference between the shift amounts ΔVth of the I-V characteristics.

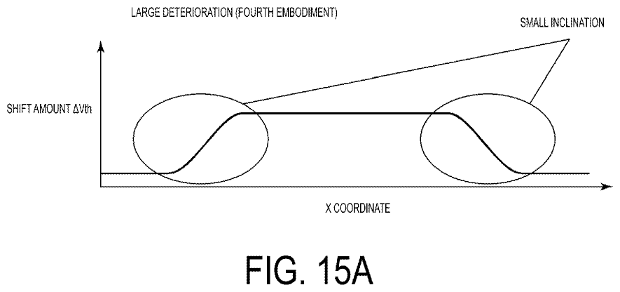

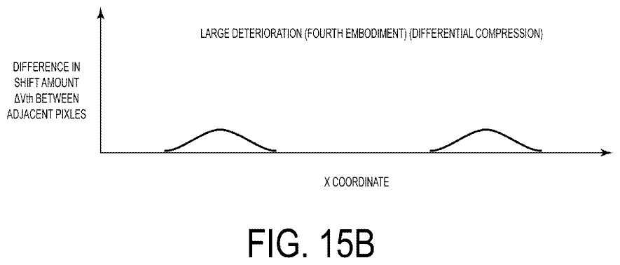

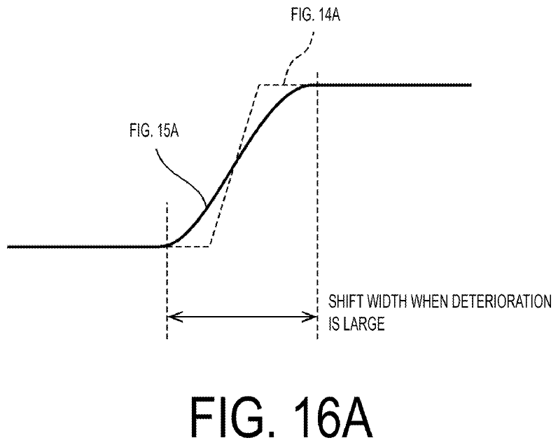

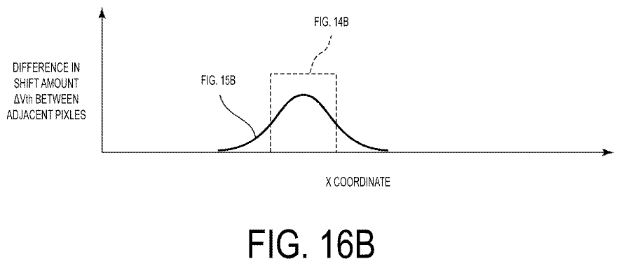

FIG. 15A is a diagram illustrating the shift amount ΔVth of the I-V characteristic in the X-axis direction of the display panel 4 (see FIG. 2B), when the shift distance of the display region 4a is increased as the average degree of deterioration of the display device 10 according to the present embodiment increases. FIG. 15B is a diagram illustrating the difference between the shift amounts ΔVth of the I-V characteristics in the X-axis direction of the display panel 4 (see FIG. 2B), when the shift distance of the display region 4a is increased as the average degree of deterioration of the display device 10 according to the present embodiment increases. FIG. 16A is a partial enlarged view in which FIG. 14A and FIG. 15A are overlaid with each other in order to compare FIG. 14A with FIG. 15A. FIG. 16B is a partial enlarged view in which FIG. 14B and FIG. 15B are overlaid with each other in order to compare FIG. 14B with FIG. 15B.

As can be seen from FIG. 15A and FIG. 16A, when the shifting amount ΔVth of the display region is increased, the inclination of a level difference portion in the graph becomes smaller compared with when the shifting amount ΔVth of the display region is small. In this way, as can be seen from FIG. 15B and FIG. 16B, the difference between the shift amounts ΔVth of the I-V characteristics of the adjacent pixels becomes small. As a result, it is possible to suppress a decrease in the compression rate of the data compression of the difference between the shift amounts ΔVth of the I-V characteristics of the adjacent pixels.

In addition, the display region shifting unit 1 may increase an interval between timings of shifting the display region 4a as the average degree of deterioration increases. A degree of progress of the deterioration of the pixel is large at the initial stage of using the display panel 4, but becomes smaller as the display panel 4 continues to be used. Thus, the interval between the timings of the shift may be reduced at the initial stage of using of the display panel 4, and the interval between the timings of the shift may be increased as the display panel 4 continues to be used.

Note that, in the present embodiment, the method using the so-called differential encoding has been described as the method for compressing the deterioration characteristic data in the deterioration characteristic storage unit 6. However, the method for compressing the deterioration characteristic data in the deterioration characteristic storage unit 6 according to the present embodiment is not limited to this, and the compression by the thinning-out in the second embodiment or the compression by the two-dimensional discrete cosine transform in the third embodiment may be used. Even with these compression methods, the same effect as that obtained by the display device of each of the above-described embodiments can be obtained.

### Fifth Embodiment

Next, the display device 10 according to a fifth embodiment will be described. Note that description of points similar to those in each of the first to fourth embodiments will not be repeated below. The present embodiment differs from each of the first to fourth embodiments in the following respects.

The display device 10 of the present embodiment differs from the display device 10 of the first embodiment in that each portion of the control unit C is realized by control processing executed by the display control program. The display device 10 according to the present embodiment has a similar configuration to that of the display device 10 according to the first embodiment with respect to other points.

More specifically, the display region shifting unit 1, the deterioration compensation unit 2, the drive unit 3, the deterioration characteristic acquisition unit 5, the deterioration characteristic storage unit 6, and the average degree-of-deterioration calculation unit 67 are realized by the control processing executed by the display control program.

In other words, a computer serving as the control unit C includes, as a main hardware configuration, a processor that operates in accordance with the display control program, for example, a central processing unit (CPU). As long as the processor can realize the functions by executing the display control program, any type of processor may be used. The processor is configured with one or multiple electronic circuits including a semiconductor integrated circuit, for example, an integration circuit (IC) or a large scale integration (LSI). The multiple electronic circuits may be integrated into one chip, or may be provided in a plurality of chips. The plurality of chips may be aggregated into one device, or may be provided in a plurality of devices.

The display control program is recorded in a tangible non-transitory recording medium such as a computer-readable read only memory (ROM), an optical disk, a hard disk drive, or the like. A content providing program may be stored in advance in the recording medium, or may be supplied to the recording medium via a wide-area communication network including the Internet or the like.

### REFERENCE SIGNS LIST

1 Display region shifting unit
2 Deterioration compensation unit
3 Drive unit
4 Display panel
4a Display region
5 Deterioration characteristic acquisition unit
6 Deterioration characteristic storage unit
10 Display device
67 Average degree-of-deterioration calculation unit

1. A display device comprising:
a display panel including a plurality of pixels and configured to display an input image corresponding to input image data, in a display region formed by a part of the plurality of pixels;
a deterioration characteristic acquisition unit configured to acquire deterioration characteristic data indicating a degree of deterioration of each of the plurality of pixels;
a deterioration characteristic storage unit configured to compress the deterioration characteristic data, store the deterioration characteristic data being compressed, and decompress the deterioration characteristic data being stored;
a display region shifting unit configured to generate, from the input image data, shifted image data in which the display region is shifted along a display surface of the display panel;
a deterioration compensation unit configured to generate control data obtained by transforming the shifted image data using the deterioration characteristic data being decompressed, to compensate for the deterioration of each of the plurality of pixels; and
a drive unit configured to drive the display panel using the control data, to display the input image in the display region being shifted.

2. The display device according to claim 1,
wherein the deterioration characteristic storage unit uses, as the deterioration characteristic data stored in the deterioration characteristic storage unit and compressed, a difference between two of the degrees of deterioration respectively corresponding to two of the pixels adjacent to each other among the plurality of pixels.

3. The display device according to claim 1,
wherein the deterioration characteristic storage unit
compresses the deterioration characteristic data by thinning out the deterioration characteristic data,
stores the deterioration characteristic data being compressed, by storing the deterioration characteristic data being thinned out, and
decompresses the deterioration characteristic data being stored, by interpolating the deterioration characteristic data being thinned out.

4. The display device according to claim 1,
wherein the deterioration characteristic storage unit
compresses the deterioration characteristic data by transforming the deterioration characteristic data into frequency domain data and removing a high frequency component from the frequency domain data being transformed,
stores the deterioration characteristic data being compressed, by storing the frequency domain data from which the high frequency component is removed, and
decompresses the deterioration characteristic data being stored, by inversely transforming the frequency domain data being stored, into the deterioration characteristic data.

5. The display device according to claim 1, further comprising
an average degree-of-deterioration calculation unit configured to calculate an average degree of deterioration of the plurality of pixels using the deterioration characteristic data acquired by the deterioration characteristic acquisition unit or the deterioration characteristic data decompressed by the deterioration characteristic storage unit,
wherein as the average degree of deterioration becomes higher, the display region shifting unit increases a shift distance of the display region.

6. The display device according to claim 1, further comprising
an average degree-of-deterioration calculation unit configured to calculate an average degree of deterioration of the plurality of pixels using the deterioration characteristic data acquired by the deterioration characteristic acquisition unit or the deterioration characteristic data decompressed by the deterioration characteristic storage unit,
wherein as the average degree of deterioration becomes higher, the display region shifting unit increases an interval between timings of shifting the display region.
